(19) United States
(12) Patent Application Publication
(10) Pub. No.: US 2011/0277372 A1
(43) Pub. Date: Nov. 17, 2011

(54) FISHING LURE HAVING RECORDED BAIT SOUND PLAYBACK MODULE

(76) Inventor: Kenneth Dale Thomas, Kalaheo, HI (US)

(21) Appl. No.: 13/189,548

(22) Filed: Jul. 24, 2011

Related U.S. Application Data
(63) Continuation-in-part of application No. 12/171,917, filed on Jul. 11, 2008, now abandoned.
Application No. 12/171,917 is a continuation-in-part of application No. 12/562,914, filed on Sep. 18, 2009, now abandoned.
Application No. 12/562,914 is a continuation-in-part of application No. 12/945,193, filed on Nov. 12, 2010, now abandoned.

(51) Int. Cl. A01K 85/01

(52) U.S. Cl. 43/42.31

(57) ABSTRACT

An electronic sound module in a fishing lure in the water is activated by a fisherman on the shore to broadcast a pre-recorded actual or simulated sound of a bait creature. In a preferred embodiment a motion sensor in the sound module activates the sound chip and micro speaker when the fisherman tugs on the line. An alternate embodiment remote radio controlled robotic fishing lure device replicates bait animals in size, shape, movement and sound.

### CROSS-REFERENCE TO RELATED APPLICATIONS

The present application is a continuation-in-part of utility patent applications Ser. No. 12/171,917 filed Jul. 11, 2008 and Ser. No. 12/562,914 filed Sep. 18, 2009 and Ser. No. 12/945,193 filed Nov. 12, 2010.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to a fishing lure and in particular to a fishing lure device having a sound module broadcasting actual or simulated recorded bait animal sounds from inside a body resembling the size, shape, and optionally the movement of the bait animal in the water.

### Description of Related Art Including Information Disclosed Under 37 CFR 1.97 and 1.98

In order to be highly effective in catching fish, such as bass, it is necessary to replicate the bait animals, fish, and insects that they prefer for food as closely as possible including sound, shape, and motion.

The prior art remote controlled fishing lures all focus in one way or another on using a cell phone type vibrator motor for vibration only and have no legs or tail that are remote controlled and do not reproduce bait animal sounds. They are often expensive to make and do not rely on simple mechanical operation. Related prior art patents and published patent applications include

U.S. Pat. No. 6,684,556,B1, U.S. 20050257418A1, U.S. 20040200125A1, U.S. Pat. No.6,920,714, U.S. 7,055,280, U.S. 6,836,995, U.S. 6,804,909, U.S. 6,789,347, U.S. 6,910,294, U.S. 20020014031A1, U.S. 6,449,895, U.S. 6,581,319, U.S. 6,035,574, U.S. 5,894,692, U.S. 5,535,538, U.S. 5,321,905, U.S. 5,105,573, U.S. 4,922,647, U.S. 4,380,132, U.S. 3,841,012, U.S. 7,207,135, U.S. 7,080,476, U.S. 20050150151A1, U.S. 6,880,287, U.S. 20030115788A1, U.S. 6,779,291, U.S. 20030154642A1, U.S. 20020104250A1, U.S. 20020088165A1, U.S. 6,192,617, U.S. 5,172,510, U.S. 4,980,987, U.S. 4,884,359, U.S. 4,858,370, U.S. 4,700,501, U.S. 4,676,020, U.S. 4,581,841, U.S. 4,594,806, U.S. 4,468,879, U.S. 4,177,597, U.S. 4,133,135, U.S. 3,465,464, U.S. 3,457,667.

What is needed is a fishing lure device containing a sound module which broadcasts the actual or simulated recorded bait creature sound from a replicated bait creature body in the water controlled by the fisherman.

### BRIEF SUMMARY OF THE INVENTION

An object of the present invention is to provide fishing lure device containing a sound module which broadcasts the actual or simulated recorded bait creature sound from a replicated bait creature body lure in the water, wherein the sound is preferably produced by a sound module inside the lure via a micro speaker communicating with a micro chip having the recorded actual or simulated sound of the bait creature which is broadcast through the micro speaker when activated by a motion sensing device activated by tugging on the fishing line attached to the lure, which also imparts a movement to the lure.

An alternate object is to produce a fishing lure device containing a sound module which broadcasts the actual or simulated recorded bait creature sound from a replicated bait creature body in the water, wherein the sound is produced by a remote radio controlled robotic fishing lure device replicating bait creatures in size, shape, and movement and transmitting actual or simulated recorded bait creature sounds, which utilizes a simple magnetic actuator and programmable sound device remotely controlled to activate simulated bait creature extremity movement and sounds.

In brief, a primary unique feature of the present invention is embedding a sound module inside a replicated bait creature body, with sound module broadcasts the transmission of a recorded actual or simulated sound of an actual bait creature simply by tugging on the fishing line attached to a simulated bait animal lure to activate a motion sensor to activate a micro recorder to transmit the actual or simulated recorded bait creature sound through a micro speaker while at the same time imparting a motion to the bait creature lure due to the tug on the line.

Another unique feature of the present invention is the means by which the sound module is turned on and off. Contained within the sound module is a magnetic field actuated electronic microcircuit switch that is activated by momentarily placing either the magnetic North or magnetic South end of a magnet in close proximity which causes the switch, and therefore the sound module, to be turned either on or off. When in the off position, the lithium battery contained within the sound module can be recharged by connecting an appropriate lithium battery charger positive (+) lead to the sound module line connection and the negative (−) lead to the sound module hook connection.

The sound generating module of the present invention provides a unique combination of resonant inductive charging using a battery protect circuit by inserting the lure with the module in the lure receptacle of the changer and a magnetic latch switch which enables turning the power on and off externally with a magnet.

The micro-miniature surface mount technology of the preferred embodiment of the sound module of the present invention does not use discrete components but utilizes surface mount technology making it about 1/10th the size of a discrete component module. It works the same as the discrete one with one exception. It is no longer necessary to have a magnet permanently next to the lure to turn it off. With the surface mount technology, a small pencil size wand with a small magnet on each end is used. One end has the North end and the other has the South end. Waving the South end next to the lure turns it on, waving the North end next to the lure turns it off.

The sound module may either comprise a “slip-in” module inserted in various hollow body soft rubber shaped lures or may be built into hollow plastic shapes. Either type can be made to be either floating or sinking

Another unique feature of the present invention is the baby alligator shape. There are no lures on the market with this shape. This soft rubber hollow body lure replicates a baby alligator sound and/or shape with soft rubber extremities and may be made without any electronics at all.

There are many lures that can use the technology of the present invention. For bass fishing, some of the basic types of hollow body soft plastic lures envisioned to use the sound modules of the present invention include:
1—e-Bassfrog A frog form which makes a “ribbit” sound and has interchangeable legs.
2—e-Basspop A popper form which makes a “popping chugging” sound and has interchangeable legs.
3—e-Bassgator A hatchling gator form which makes a hatchling gator “squeeking” sound has both legs and a tail that swings side to side.
4—e-Basscrayfish A crayfish form which makes crayfish “clicking” sounds.
5—e-Basschad A chad form which makes chad “rattling buzzing” sounds.

The components for reproducing the actual or simulated sound of the bait creature are encapsulated in a waterproof sound module which is inserted in the hollow simulated bait creature body. The housing is placed within a hollow soft rubber body of whichever shape you choose; frog, gator, crayfish, shad, popper or other bait creature. The lure body can therefore be changed very easily if and when it gets damaged. The sound module insert reproduces the pre-recorded actual or simulated sound of the bait animal.

In the solid body form, the appendages may be removable so that a fisherman can change the legs when they get ripped without having to change the lure body and he can change the legs to the type and color he wishes as conditions change.

The sound module is preferably encapsulated in a material that makes it buoyant or in the case of the crayfish non-buoyant, so the lures can either float or sink depending on the choice of lure type.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a sectional side view of a first embodiment of the invention, illustrating a remote radio controlled artificial fishing lure with legs, to create a fishing lure in a shape that emulates a frog, baby alligator, mouse, rat, aquatic insect, or other chosen shape;

FIG. 2 is a bottom view of the first embodiment of the invention illustrating the various components of the fishing lure;

FIG. 3 is perspective top view of a second embodiment device illustrated as an alligator wherein both front legs, both back legs, and the tail can move either independently or in any combination;

FIG. 4 is a top sectioned view of the second embodiment device;

FIG. 5 is a side sectioned view of the second embodiment device;

FIG. 6 is a top sectioned view of a third embodiment device;

FIG. 7 is a top plan view of the remote control of the present invention;

FIG. 8 is a sectional side view of the remote control of FIG. 7;

FIG. 9 is a side sectioned view of a basspop body having the radio receiver, batteries, and magnetic actuator with an actuator arm in the body interior;

FIG. 10 is a side sectioned view of a basspop body having alternate positioning of the radio receiver, batteries, and magnetic actuator with an actuator arm in the body interior;

FIG. 11 is a top sectioned view of a basspop body having the radio receiver, batteries, and magnetic actuator with an actuator arm in the body interior and showing the external legs;

FIG. 12 is perspective top view of another embodiment device of the present invention illustrated as a baby frog or tadpole with tail-like streamers showing the internal power source, receiver, and sound transmitter;

FIG. 13 is perspective top view of another embodiment device of the present invention illustrated as a baby frog with wagging feet showing the internal power source, receiver, and sound transmitter;

FIG. 14 is perspective top view of another embodiment device of the present invention illustrated as a rounded rectangular body with trailing hook showing the internal power source, receiver, and sound transmitter;

FIG. 15 is perspective top view of another embodiment device of the present invention illustrated as a large insect with tail-like streamers showing the internal power source, receiver, and sound transmitter;

FIG. 16 is a schematic top plan view in section of the bait sound producing fishing module of the present invention showing the interior components and the two conductive end extensions used in charging the internal battery powering the internal sound recording and playback chip and micro speaker for playing the pre-recorded actual or simulated sound of a bait creature for catching fish;

FIG. 17 is a schematic side elevational view in section of the bait sound producing fishing module of FIG. 16;

FIG. 18 is perspective top view of the bait sound producing fishing module housed inside a rubberized bait creature body simulating a baby frog or tadpole with tail-like streamers showing the bait creature body floating in water with the tail tilted downward;

FIG. 19 is perspective top view of the bait sound producing fishing module housed inside the rubberized bait creature body of FIG. 18 showing the bait creature body floating in water with the head tilting downward caused by a tug on the fishing line thereby activating the broadcasting of the recorded bait creature sound from the fishing module;

FIG. 20 is a side elevational view of a sound module fit within a soft rubber fishing lure (shown dashed) in the shape of a shad, having a hollow body cavity that the module slips into;

FIG. 21 is a schematic plan view of the preferred embodiment of the bait sound producing circuit and the charging circuit of the present invention, the sound producing circuit comprising an internal rechargeable battery powering the internal sound recording and playback chip and micro speaker for playing the pre-recorded actual or simulated sound of a bait creature for catching fish and a resonant inductive charging circuitry including an inductance pickup coil, a battery protect circuit and a magnetic latch switch all using micro-miniature surface mount technology, and the inductance coupled battery charger comprising a mating inductance coupling coil positioned so that the coils are in close proximity to charge the battery inside the module and the lure;

FIG. 22 is a schematic view of the sound module containing the sound producing circuitry of FIG. 21;

FIG. 23 is a diagrammatic cross-sectional elevation view of the battery charger of the preferred embodiment of the present invention showing the charging circuit of FIG. 21 inside the charger and a receptacle for receiving the lure containing the sound producing module of FIG. 22 and showing the inductance pickup coil of the sound module in the lure and the mating inductance coupling coil positioned so that the coils are in close proximity to charge the battery inside the module and the lure;

FIG. 24 is a perspective view of the battery charger of FIG. 23 showing the power button and charge indicating light on the top of the battery charger case and the sound producing lure lined up for insertion in the lure receptacle on the top surface of the case;

FIG. 25 is a perspective view of the battery charger of FIG. 24 showing the sound producing lure removably inserted in the lure receptacle on the top surface of the case for recharging the battery.

### DETAILED DESCRIPTION OF THE INVENTION

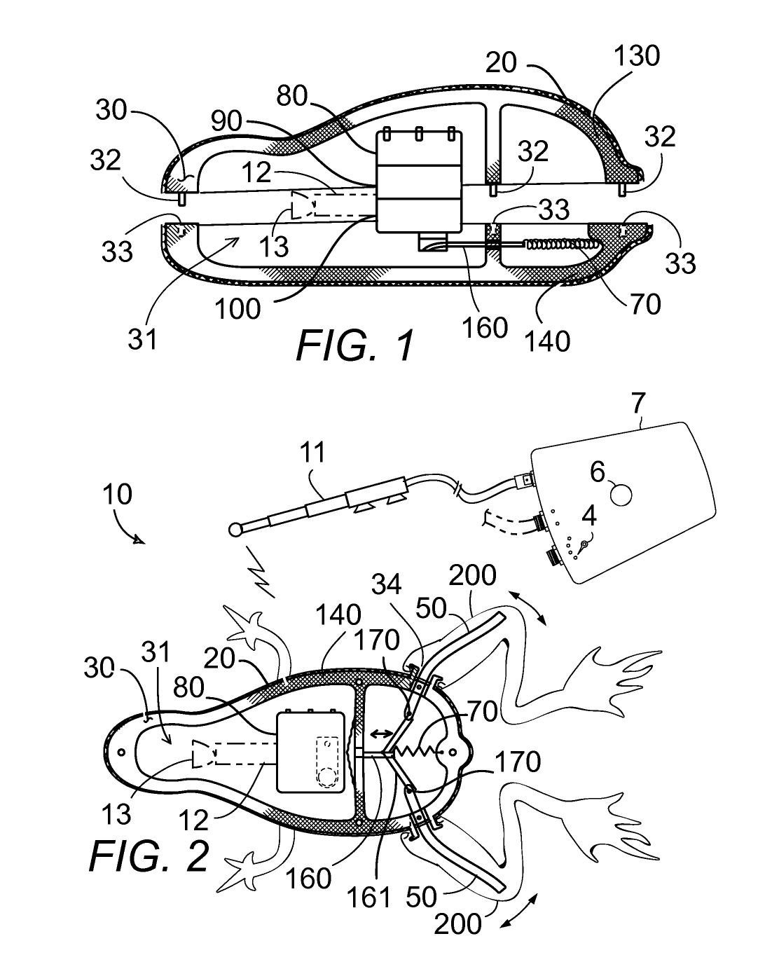

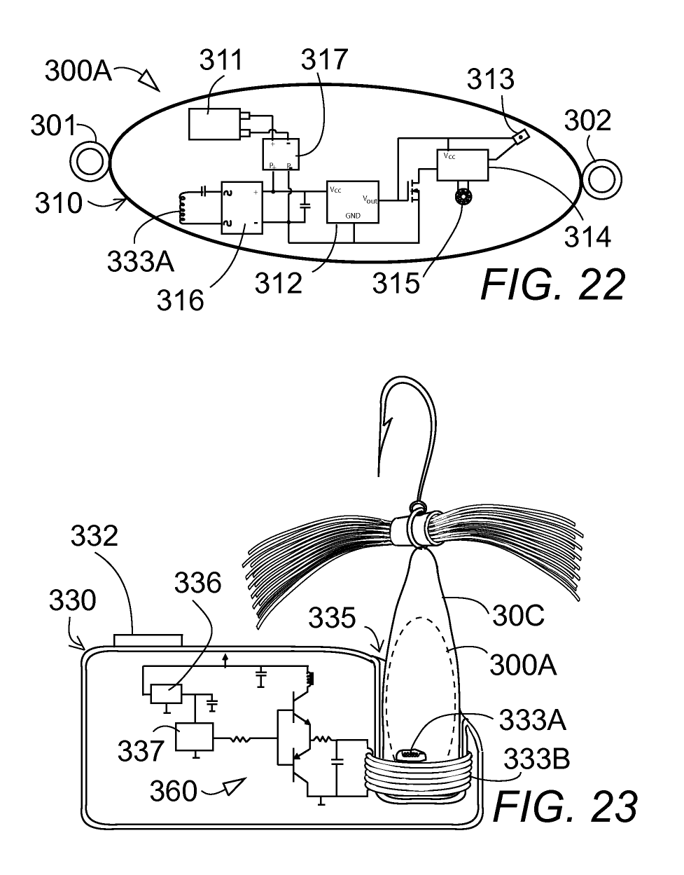

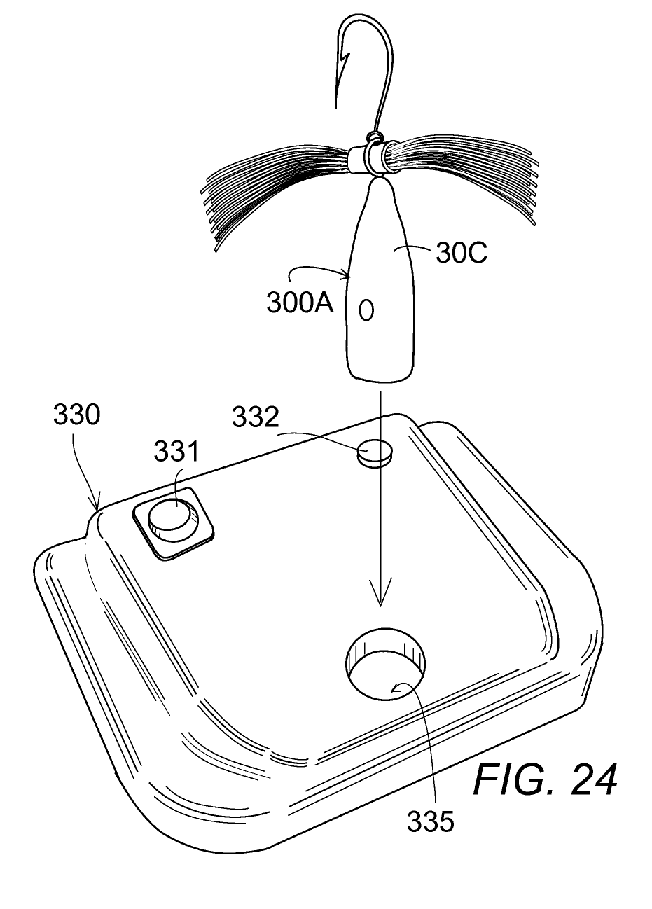

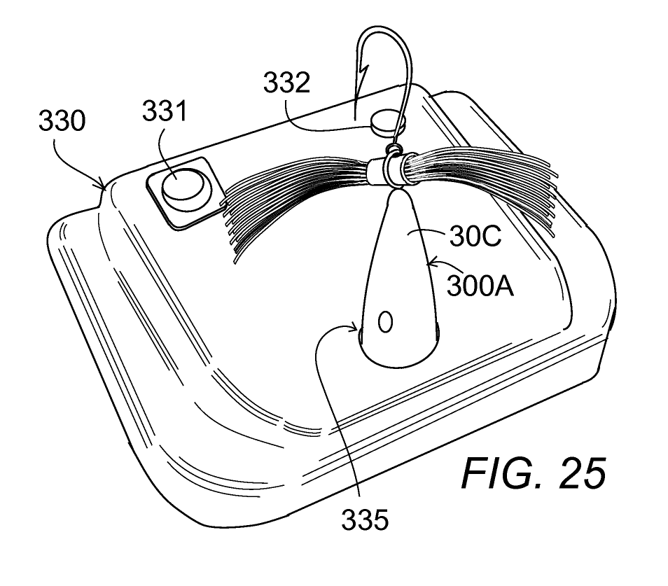

In FIGS. 1-25, a bait sound producing microchip 12 and 314 and micro speaker 13 and 315 preferably in a waterproof bait creature sound producing module 150 and 300 in a fishing lure 30, 30A, 30B and 30C include self contained electronics inside to broadcast sound reproductions of pre-recorded actual and simulated bait creature sounds appropriate to the shape of the lure when activated by a fisherman, as well as means for creating appropriate motion in the lure.

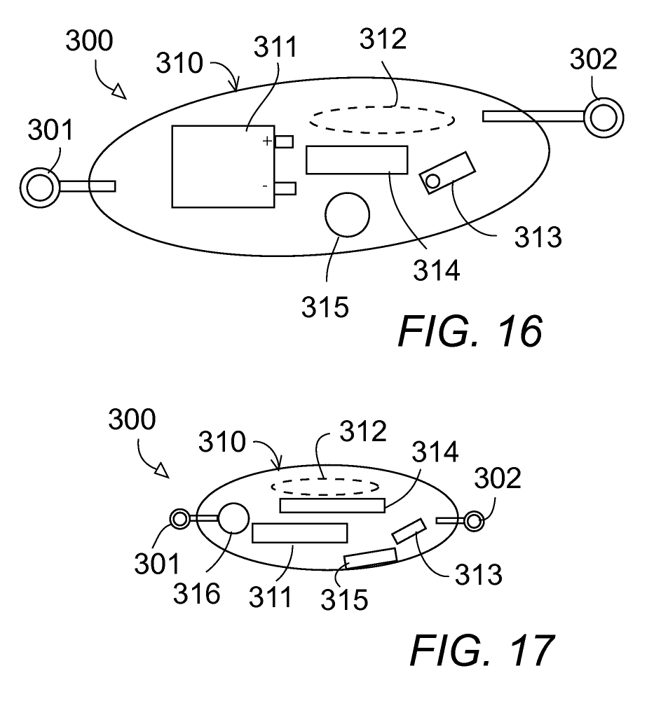

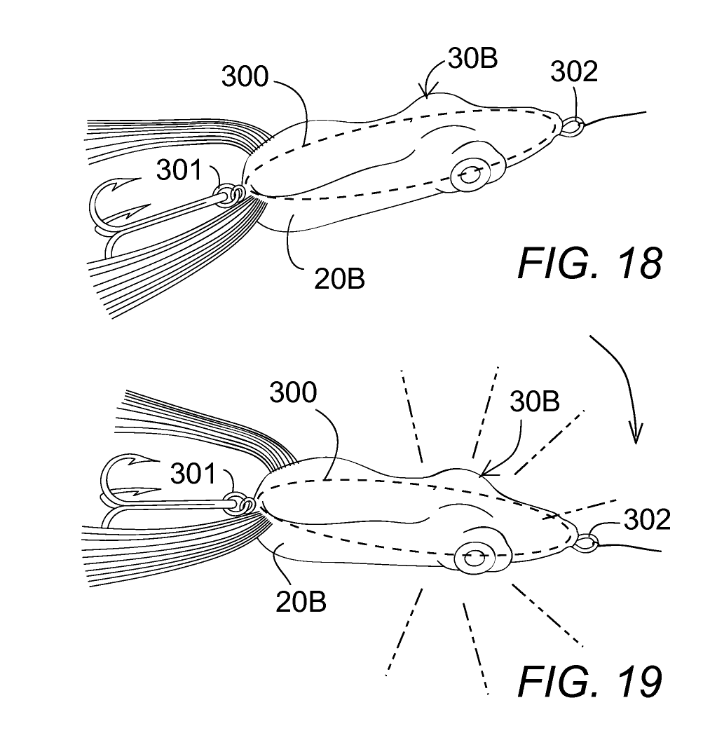

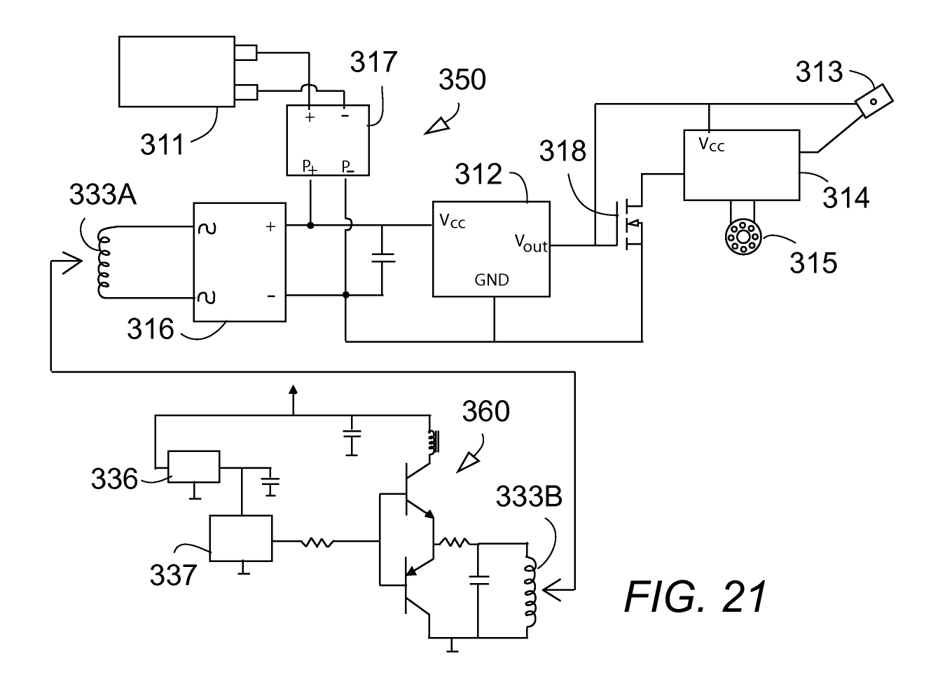

In FIGS. 21-25, a preferred embodiment of the bait creature sound producing module 300A, and in FIGS. 16-19, another embodiment of the bait sound producing fishing module 300, are each removably housed in a fishing lure device, such as a popper type lure 30C, as shown in FIGS. 23-25, or a rubberized bait creature body 30B simulating a baby frog or tadpole with tail-like streamers, as shown in FIGS. 18 and 19, each have self contained electronics inside to broadcast an actual or simulated sound reproduction of a bait creature sound when activated by the fisherman.

Each of the watertight bait sound producing modules 300A and 300 is removably inserted inside a fishing lure body 30C and 30B. The bait sound producing module comprises a water proof pod 310 having an exterior water tight housing and an interior space within the housing to house an electronic circuit, a recorded sound producing chip 314 having a pre-recorded bait creature sound recorded thereon, a micro speaker 315 to broadcast the pre-recorded bait creature actual or simulated sound, a power source 311 to power the electronic circuit and the recorded sound producing chip 314 and the micro speaker 315, and means for a fisherman to activate the electronic circuit remotely to activate the pre-recorded bait creature sound on the recorded sound producing chip 314 and broadcast the pre-recorded bait creature sound through the micro speaker 315, with the sound producing module 300A and 300 inside the fishing lure body in the water to attract fish that feed on the bait creature species.

The means for a fisherman to activate the electronic circuit remotely comprises a motion switch 313 inside the module 300A and 300. The motion switch 313 communicates with the electronic circuit and the sound chip 314, so that a tug by a fisherman on a fishing line connected to the fishing lure body at the line receiving ring 302, causes the tilting of the fishing lure to trigger the motion switch to activate the electronic circuit and the chip to produce the pre-recorded sound of the bait creature, as shown in FIGS. 18 and 19.

The fishing lure body 30B preferably simulates the body of the bait creature which produces the sound recorded and reproduced by the sound module in the fishing lure body and the tug on the fishing line creates motion to simulate motion of a bait creature, as shown in FIG. 19.

The sound module 300 and the fishing lure 30B are fabricated of buoyant material to float in the water with a tail end of the fishing lure angled downwardly or a sinking material with the lure sitting on the bottom at an angle, as shown in FIG. 18, so that a tug on the fishing line attached to the front of the floating fishing lure causes the front of the fishing lure to tilt downwardly to trigger the motion switch 313, as shown in FIG. 19.

The recorded sound producing chip 314 generates a pre-recorded simulated or actual sound of a live bait creature sound taken in a natural environment and taken from a list of simulated or actual sounds including a frog ribbit sound, a basspop cricket sound, a baby hatchling alligator squeaking sound, a crayfish clicking sound, a shad rattling buzzing sound, a mouse squeaking sound, a rat squeaking sound, a small fish sound in the water, and an aquatic insect sound in the water.

The sound module further comprises an on-off magnetic latch switch 312 so that swiping a South pole of a magnet past the lure activates the sound module circuit for use in the water and swiping a North pole of a magnet past the lure de-activates the sound module circuit for storage.

In FIGS. 21-25, the preferred embodiment power source comprises a rechargeable battery 311 connected to an inductance pickup coil 333A and the lure 30C is removably inserted in a receptacle 335 for receiving the lure in an inductance coupled battery charger 330 comprising a mating inductance coupling coil 333B adjacent to (preferably surrounding) the receptacle so that the coils are in close proximity to charge the battery inside the module 300 without removing the module from the lure.

In FIGS. 23-25, a popper type lure 30C is dropped into the cup or lure receptacle 335 of the charger 330 and the charger automatically charges the battery 311 in the sound module 300A. The charger runs off 12 Vdc from a wall wart, car cigarette lighter socket or hooked up to the boat power or any 12 Vdc source.

A rare earth magnet turns the magnetic actuated latch switch 312 on or off When the switch is on, it latches a ground on the gate 318, connecting the battery 311 to activate the programmable sound module 314. When the motion switch 313 detects a motion it triggers the sound module 314 to output the stored sound recording to the speaker 315. The sound module is turned on by swiping the South pole of a magnet past magnetic actuated latch switch 312. Swiping the North pole turns it off

The coupling coil 333B and pickup coil 333A form a resonant tank circuit which detects the AC magnet field created by the external inductance coupled battery charger 330 with a coupling coil 333B. The full wave bridge rectifier (FWBR) 316 converts the AC into DC. This filtered DC is applied to the battery protect circuit 317 which both protects and charges the Lithium battery 311 in a controlled manner.

The preferred embodiment of FIGS. 21-25 utilizes surface mount technology rather than discrete electronic components to make it about 1/10th the size. † It works the same as the discrete one with one exception. You no longer need to have a magnet permanently next to the lure to turn it off. In the new design you just have a \ small pencil size wand with a small magnet on each end. One end has the North end and the other has the South end. If you wave the South end next to the lure it turns it on, if you wave the North end next to the lure it turns it off.

The charger is in a little cup like fixture and you just have to place the front end of the lure in the cup and it automatically charges the battery in the lure.

With the preferred embodiment it is no longer required to place a magnet next to the lure to turn it on and off. It is now turned on and off by swiping a magnet past the lure. Swipe the South pole by the lure and it turns on. Swipe the North pole by the lure and it turns off. Also, it is no longer necessary to connect clip leads to the line and hook eyes to charge the battery. Simply place the line end of the lure in a cup charger and it is inductively coupled and charges the battery without having to hook anything up to the lure. Like a rechargeable tooth brush. The attached diagram shows that circuit.

The sound module may be applied either as a “slip-in” to various hollow body soft rubber shapes or built into hollow plastic shapes. The preferred embodiment provides resonant inductive charging, a battery protect circuit, and a magnetic latch switch.

In FIGS. 16-19, the alternate embodiment of the fishing lure body 30B further comprises an electrically conductive means, such as line receiving loop 302, for attaching the fishing line at a forward end and an electrically conductive hook attaching loop 301 for hooking a fish at a rearward end. The power source comprises a rechargeable battery 311, preferably a Lithium Polymer battery which connects to the electrically conductive line receiving loop 302 means for attaching the fishing line and the electrically conductive hook receiving loop 301 means for hooking a fish, so that the rechargeable battery 311 is rechargeable inside the sound module by attaching leads from a lithium battery charger to the two loops without removing the rechargeable battery from the sound module.

The sound module is turned on and off by a magnetic field actuated electronic microcircuit switch inside the sound module that is activated by momentarily placing either the magnetic North or magnetic South end of a magnet in close proximity which causes the switch, and therefore the sound module, to be turned either on or off. When in the off position, the lithium battery contained within the sound module can be recharged by connecting an appropriate lithium battery charger positive (+) lead to the sound module line connection and the negative (−) lead to the sound module hook connection.

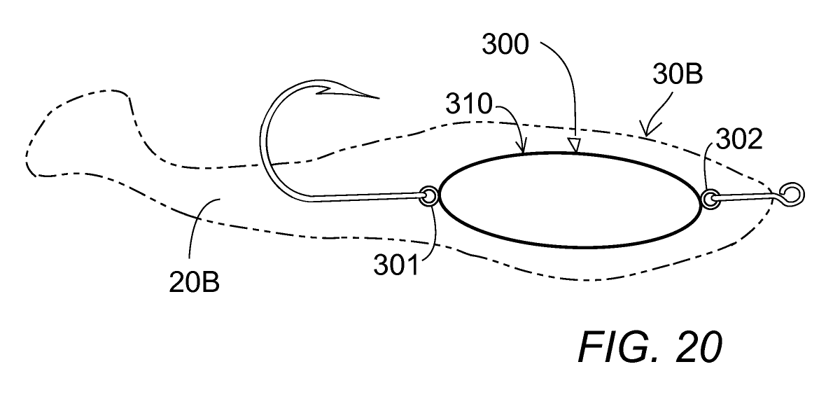

In FIG. 20, a soft rubber shad fish shaped lure 30B has a flexible rubberlike simulated body 20B having a hollow body cavity that the sound module 300 slips into. The form is basically silver colored with a black dot on the side and yellow on the very end of the tail and has red lips. The modules size ranges from 1 ½″ to 2 ½″ long and ½″ to ⅝″ in diameter and are torpedo shaped. Shad is a small minnow like fish that grows to be perhaps 3 to 4 inches long. They are slim, silver and congregate in large schools. They are the bass 2nd preferred food source after crayfish. They make a sort of rattling, buzzing sound when the bass attacks the school and they flee. They catch bass, catfish, walleye, pike, trout, crappie, anything that can catch them.

In use, the preferred embodiment of the floating lure containing a sound module of the bait creature sought by the type of fish in the water being fished is cast into the area believed to hold bass or other type of fish desired and allowed to sit still for a short time either floating or on the bottom depending on lure choice. At that time the lure will sit in a slightly tail down posture causing the sound module within the lure to be off. When the lure is later “twitched” by a gentle tug on the fishing line connected to the lure to produce motion in the lure to simulate a live bait creature, wherein the lure tips slightly forward causing the motion detection switch within the module to create a electronic trigger signal which turns on the programmable sound I.C. which sends a pre-recorded actual or simulated frog, crayfish, shad, hatchling gator, cricket, or other bait creature sound to a miniature waterproof speaker on the bottom on the sound module. This causes the lure to both wriggle in the water and to emit an actual or simulated sound of a frog, crayfish, hatchling gator, shad, cricket, or other bait creature.

The Lithium Polymer battery 311 within the sealed module 310 is rechargeable by placing a magnet in close proximity to the built in magnetic reed switch 312. This causes the battery to be connected directly to the front line (+) ring 302 and the rear hook (−) ring 301 for charging. Note: as the battery is not connected to the (+) ring when the module is activated by removing the magnet, the lure can be used in both salt and fresh water without discharging the battery via the water.

The legs of a fisherman's choice , color, shape etc. can be easily inserted into the lure body to simulate the bait creature preferred by the type of fish the fisherman desires to catch.

The electronic sound module may be built in as a part of a complete lure or a sound module can be inserted into a hollow rubber form and when activated causes a pre-recorder frog, crayfish, shad, cricket, gator, or other bait creature sound. When activated the sound module produces an electronic pre-recorded audio actual or simulated sound of a frog, gator, crayfish, shad, cricket, or other bait creature housed in a mating bait creature simulated body matching the bait creature sound produced.

The sound module is a little smaller and the same shape as an adult thumb. What is needed is a lure that closely replicates the size, shape, color and sound of a frog, crayfish, hatchling gator, shad, cricket, or other bait creature which are primary food sources of bass. This lure fills all those needs. A small self contained sealed electronic sound producing module that is activated by a tipping movement of the module.

The lure module has a programmable integrated circuit (I.C.) that is programmed with the recording of the actual or simulated sound of a frog, a hatchling gator, a crayfish, a shad, a cricket, or other bait creature. The module has a magnetic built in reed switch. When a magnet is in close proximity to the switch the sound module is off and the internal Lithium Polymer battery is connected directly to the line connection (+) and the hook connection (−) for charging. When the magnet is removed, the battery is disconnected from the (+) terminal and is connected to the module electronics which turns on the module. When the module is tipped it creates an electronic trigger signal that causes the speaker to emit the pre-recorded sound. The module can be placed within the hollow rubber form of a frog, crayfish, gator, shad, or other bait creature shape of choice or built into a hollow body plastic lure of any shape. Typical hollow lure bodies have the feature wherein the “legs” can be exchanged readily without affecting the module. Note that the stand alone module has no leg slots as the hollow rubber forms contain the slots. When the module is built into a hollow plastic form that form has the leg slots.

In FIGS. 1-19, a remote radio controlled robotic fishing lure device 10 records and plays back a bait creature's actual or simulated recorded sound and also simulates the size, shape, and movement of the bait creature in many embodiments.

In FIG. 1, a watertight simulated body 30 of a simulated fishing bait creature, a frog in this embodiment, comprises a hard inner upper shell 130 snapped together to a hard inner lower shell 140 each with a rubberized outer covering 20 simulating the outer skin of the bait creature. Pins 32 in one half snap fit into mating holes 33 in the other half A watertight inner space 31 houses at least one radio receiver 90 and at least one magnetic actuator 100 for creating motion positioned therein. The radio receiver 90 communicates with the magnetic actuator 100. The simulated body 30 has a number of openings 34 around the perimeter for receiving extremities 50 attached thereto in a watertight fit.

The magnetic actuator 100 and 210 may comprise a rare earth magnet actuator or a servo mechanism imparting motion to the control arm.

The power source preferably comprises a rechargeable battery 80 within the lure body having battery charger connections extending outside of the lure body in the fishing line attachment ring and hook attachment ring so that the lure does not have to be taken apart or any inside access necessary at all in order to charge the battery.

The flexible simulated extremities 50 of the fishing bait creature each comprise a soft rubberized replica of an extremity 50 of the fishing bait creature, in this case a frog leg, which fits with a tight watertight fit in one of the openings 34 in the body of the fishing bait creature to plug the opening so that the body is sealed watertight. The magnetic actuator 100 is attached to each of the extremities 50 by means for linking the at least one magnetic actuator to each of the extremities to enable the at least one magnetic actuator 100 to create movement simulating the natural movement of each extremity in the fishing bait creature.

In FIGS. 1 and 2, a control arm 160 is attached to the magnetic actuator 100 and optional extension control arms 161 connecting to extremity moving arms 50 which extend from inside the simulated body into an extremity 200. Each extremity moving arm 50 is pivotally attached to the control arm wherein the magnetic actuator imparts a back and forth motion (shown by internal arrow) to the control arm 160 and the control arm imparts a movement to the extremity moving arm to create the simulated extremity movement (shown by external arrows). The control arm 160 is further attached to a spring 70 attached to the body to draw the control arm 160 toward the back after the magnetic actuator 100 drawings the control arm 160 forward to create the back and forth motion to move the extremities.

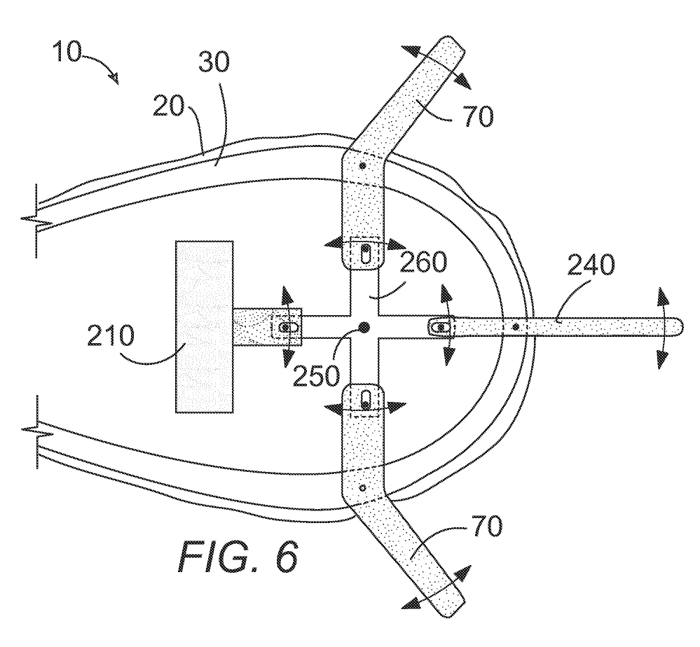

In FIG. 6, the control arm 260 pivotally attached to the actuator 210 has a plurality of extension control arms which each connect to an extremity moving arm such as leg extremity moving arms 70 and tail extremity moving arm 240 activate an extremity moving arm. The control arm 260 is further attached to a control arm pivot mechanism 250 in the center of the control arm connected to an interior surface of the simulated body.

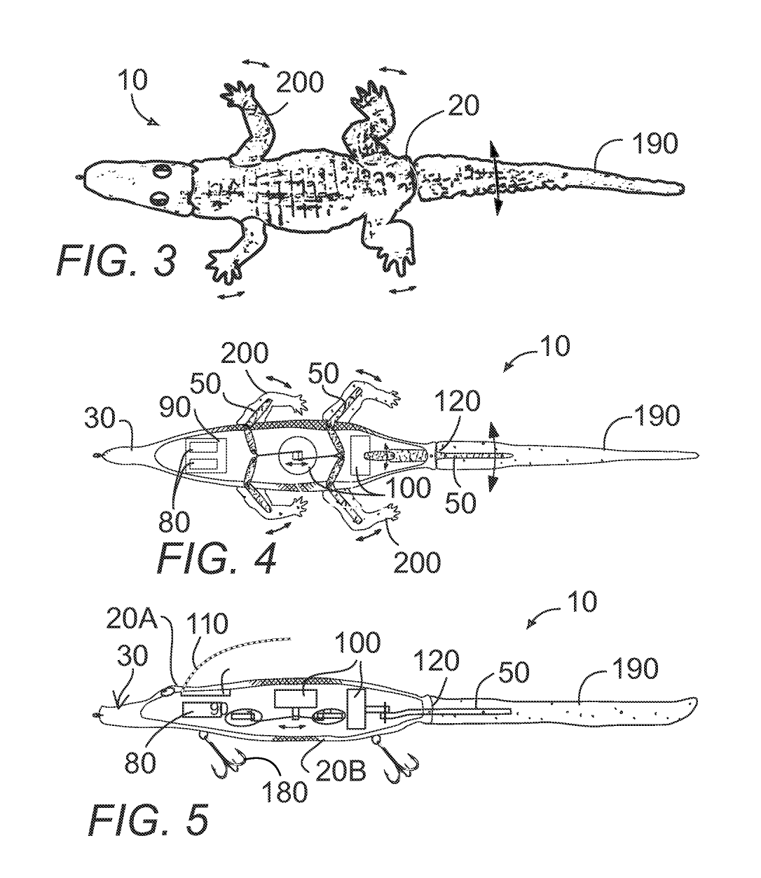

In FIGS. 1-6, the lure body comprises a molded body in the shape of a bait creature taken from the list of bait creatures comprising a frog in FIGS. 1 and 2, a baby alligator in FIGS. 3-5, a fish, and an aquatic insect.

In FIGS. 1 and 2, the molded body 30 is in the shape of a frog and the extremities 200 comprise simulated frog legs that simulate a kicking motion natural to frog legs so that the extremities simulate a natural swimming motion of a frog in water.

In FIGS. 1-5, the simulated body 30 is in the shape of a baby alligator and the extremities comprise simulated baby alligator legs 200 that simulate a kicking motion natural to baby alligator legs and a simulated baby alligator tail 190 that simulates a natural side to side swinging movement (arrows) of a baby alligator tail so that the extremities simulate a natural swimming motion of a baby alligator in water.

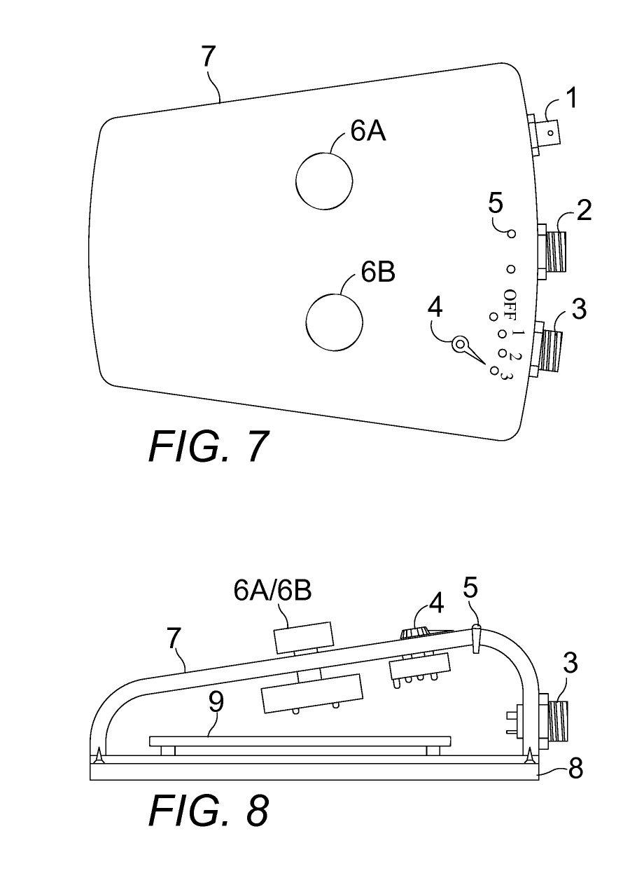

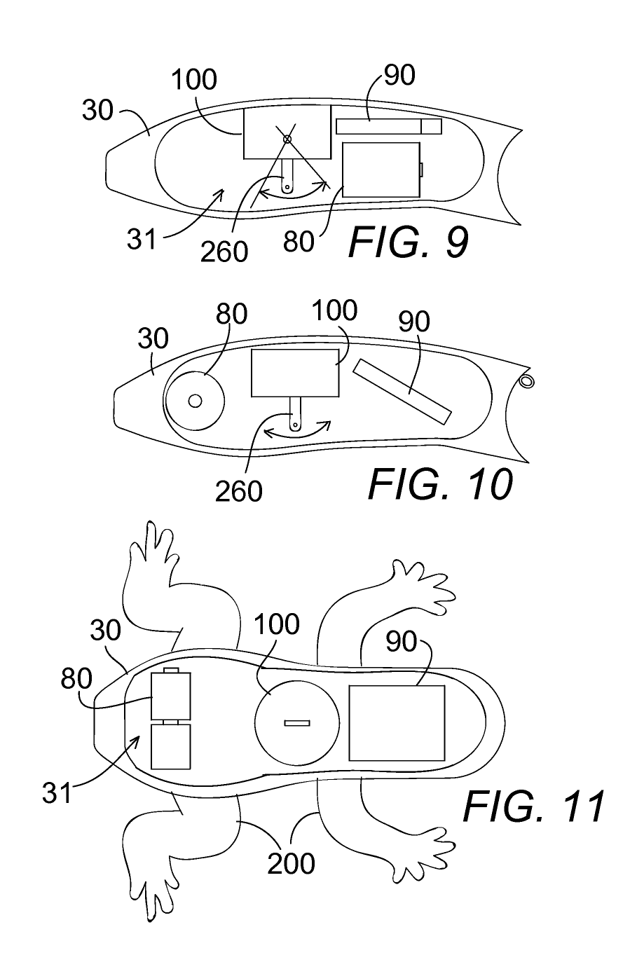

In FIGS. 9-11, the simulated body 30 with interior space 31 is in the shape of a basspop and the extremities comprise simulated basspop legs 200 that simulate a kicking motion activated by a control arm 160 attached to a magnetic actuator 100 powered by a battery or batteries 80 and receiving signals through a radio receiver 90 from the remote control (7 as in FIGS. 7 and 8) held by the fisherman.

A sound generating microchip 12 and subminiature speaker 13 for bait animal sound generation on demand are installed within the watertight simulated body 30, the microchip 12 communicating with the radio receiver so that the radio transmitter 9 sends a separate signal activated by a second foot button 6B on the remote control to the radio receiver 90 causing the radio receiver to activate the sound generating microchip 12 to make a pre-recorded sound through the subminiature speaker 13 of a natural recorded sound of the fishing bait creature. The microchip 12 generates a pre-recorded sound depending upon the nature of the fishing bait creature simulated body housing the microchip, the pre-recorded sound is of a live bait animal sound taken in a natural environment and taken from the list of simulated sounds including a frog ribbit sound, a basspop cricket sound, and a baby alligator hatchling squeaking sound.

In FIGS. 7 and 8, a hand and foot operated remote control 7 housing a radio control transmitter 9, the remote control alternately held by a user in a first position for hand control with a hand control switch 4 for turning the magnetic actuator 100 on and off and setting the choice of which robotic lure is being used, and alternately positioned near a foot of a user in a second position for foot control using a first foot actuated button 6A for controlling motion in the robotic lure and a second foot actuated button 6B for controlling sound in the robotic lure while a user holds a fishing rod, the radio control transmitter controlling the robotic fishing lure device for fishing, the radio control transmitter wirelessly communicates with the radio receiver 90 in the simulated body which activates the magnetic actuator 100 to create movement in each of the extremities 50 simulating the natural movement of each extremity in the fishing bait creature. A mating hook and loop fastener patch 8 on the bottom of the remote control allows it to be removable attached to the carpeting on a fishing boat or other convenient location. An antenna is removably attachable to the BNC antenna connector 1 on the remote control. A power source is connectable to the two conductor male power connector 2 on the remote control. The remote control is connectable to a power charge source via a two conductor female charge connector 3 on the remote control. An antenna 11 transmits the radio signals from the remote control to the receiver 90.

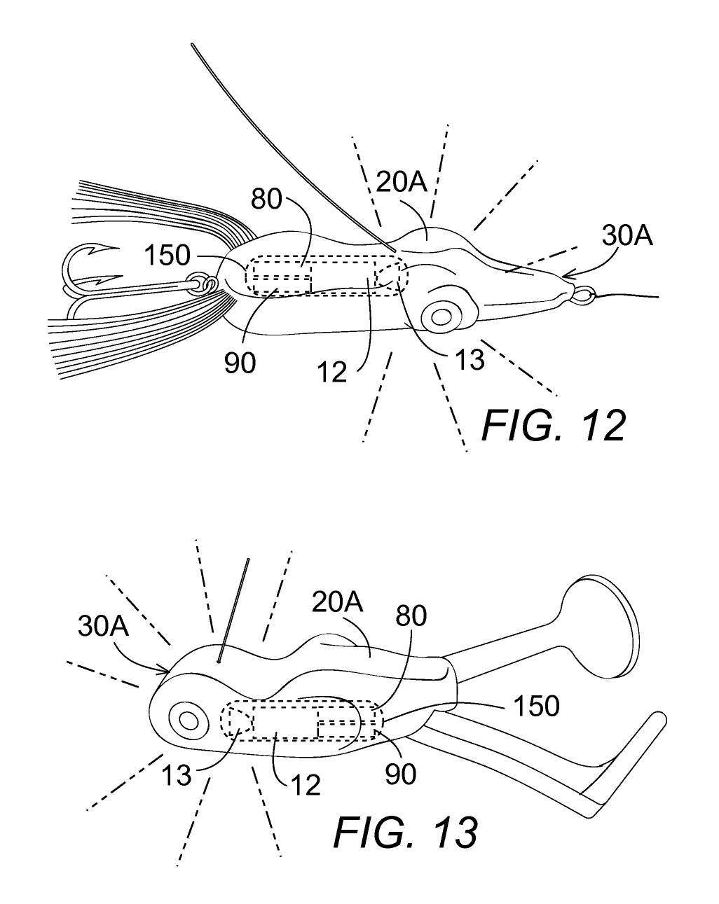

In FIGS. 12-15, an alternate watertight simulated body 30A of a simulated fishing bait creature or a similarly sized body, which may be a rubberized body and has a rubberized outer covering 20 simulating the outer skin of the bait creature and each provides a moving outer appendage element which moves as the body is dragged through the water and an internal sound generating housing 150 inserted in the body. The sound generating housing 150 encloses a sound generating microchip 12 and subminiature speaker 13 for bait animal sound generation on demand installed within the watertight simulated body 30. The microchip 12 communicates with the radio receiver 90 so that the radio transmitter 9 sends a separate signal activated by a second foot button 6B on the remote control to the radio receiver 90 causing the radio receiver to activate the sound generating microchip 12 to make a pre-recorded sound through the subminiature speaker 13 of a natural recorded sound of the fishing bait creature. The sound generating housing 150 may be fabricated of buoyant material so that the simulated body 30A floats with the sound generating housing inserted therein. The sound generating housing 150 may be removed and replaced.

In FIG. 12, the watertight simulated body 30A, having a rubberized outer covering 20A, simulates a baby frog or tadpole with tail-like streamers showing the sound generating housing 150 having an internal power source 80, radio receiver 90, sound generating microchip 12 and sound transmitter, such as a subminiature speaker 13.

In FIG. 13, the watertight simulated body 30A, having a rubberized outer covering 20A, simulates a baby frog with wagging feet showing the sound generating housing 150 having an internal power source 80, radio receiver 90, sound generating microchip 12 and sound transmitter, such as a subminiature speaker 13.

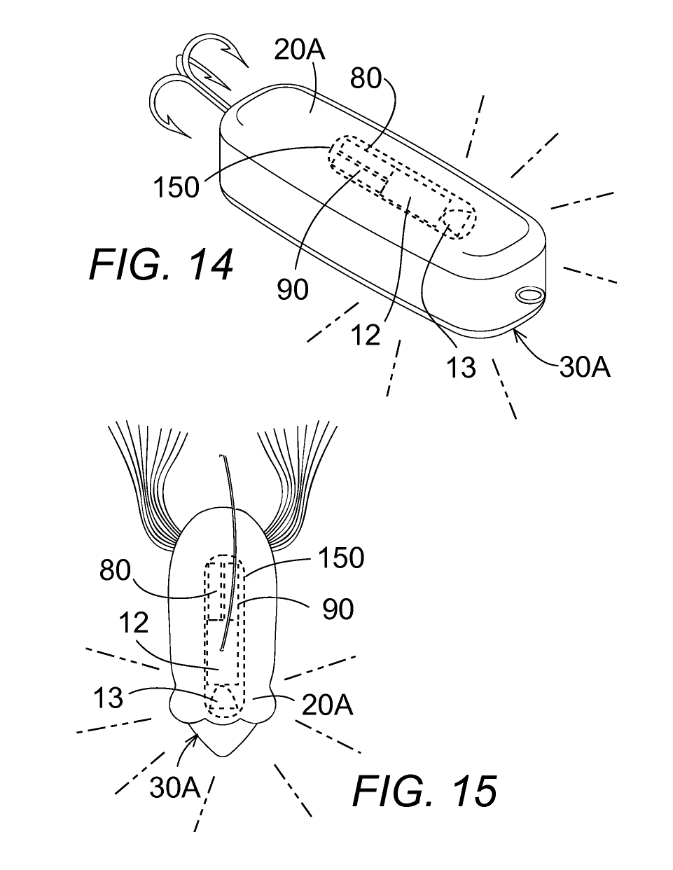

In FIG. 14, the watertight simulated body 30A as a rounded rectangular body, having a rubberized outer covering 20A, simulates the size of a fishing bait creature with trailing hook wagging behind, showing the sound generating housing 150 having an internal power source 80, radio receiver 90, sound generating microchip 12 and sound transmitter, such as a subminiature speaker 13.

In FIG. 15, the watertight simulated body 30A as a rounded rectangular body, having a rubberized outer covering 20A, simulates a large insect with tail-like streamers showing the sound generating housing 150 having an internal power source 80, radio receiver 90, sound generating microchip 12 and sound transmitter, such as a subminiature speaker 13.

In use, the watertight simulated body 30 and 30A of the radio controlled fishing bait creature is attached to a fishing line and cast into the water. The remote control 7 is turned on and adjusted to the desired choice of robotic lure being used with the manual control 4. The remote control may be placed on the ground fishing boat carpet or attached to a bait box on the ground and operated by a foot of a user on the foot control buttons 6A and 6B while the fisherman holds the fishing rod and reel with two hands. The bottom hooks 180 hook a fish attacking the lure.

It is understood that the preceding description is given merely by way of illustration and not in limitation of the invention and that various modifications may be made thereto without departing from the spirit of the invention as claimed.

### APPENDIX

Reference numbers of the parts of the invention shown in the drawings:
1 is a BNC antenna connector on the remote control.
2 is a two conductor male power connector on the remote control.
3 is a two conductor female charge connector on the remote control.
4 is the remote control on/off channel select switch for the type of robotic lure in use.
5 is the remote control green LED “active” indicator.
6A is the remote control foot switch for motion.
6B is the remote control foot switch for sound.
7 is the high impact plastic housing of the remote control device operable by a hand or a foot of a user.
8 is a hook and loop fastener adhered to the bottom of the remote control.
9 is the transmitter for the remote control.
10 is a remote radio controlled robotic artificial fishing lure device that provides motion.
20 is a soft rubber outer skin or stand alone form. This outer skin can take the shape of a frog, baby alligator, mouse, rat, aquatic insect or other desired forms.
30 is a watertight simulated body.
30A is an alternate watertight simulated body.
50 is an actuator arm.
70 is a spring.
80 is a battery.
90 is a radio control model receiver.
100 is a servo or a rare-earth magnet actuator.
110 is an antenna.
120 is a tail pivot point.
130 is a top half of lure body.
140 is a bottom half of lure body.
150 is a housing for the sound producing element
160 is a stainless steel wire.
170 is a leg attachment point.
180 is a fish hook.
190 is a silicon rubber tail.
200 is a silicon rubber leg.
210 is a magnetic actuator.
240 is a tail attach point.
250 is a main pivot point.
260 is a main control arm.

What is claimed is:

1. A bait sound producing fishing module in a fishing lure device having self contained electronics inside to broadcast sound reproduction of actual and simulated bait creature sounds when activated by a fisherman, the device comprising:
a watertight bait sound producing module removably inserted inside a fishing lure body, the bait sound producing module comprising a water proof pod having an exterior water tight housing and an interior space within the housing to house an electronic circuit, a recorded sound producing chip having a pre-recorded bait creature sound recorded thereon, a micro speaker to broadcast the pre-recorded bait creature sound, a power source to power the electronic circuit and the recorded sound producing chip and the micro speaker, and means for a fisherman to activate the electronic circuit remotely to activate the pre-recorded bait creature sound on the recorded sound producing chip and broadcast the pre-recorded bait creature sound through the micro speaker, the sound producing module inside the fishing lure body positioned in a body of water to attract fish that feed on the bait creature species, thereby providing a bait sound producing fishing module in a fishing lure device having self contained electronics inside the module to broadcast sound reproduction of actual and simulated bait creature sounds when activated by a fisherman.

2. The device of claim 1 wherein the means for a fisherman to activate the electronic circuit remotely comprises a motion switch inside the module, the motion switch communicating with the electronic circuit and the chip, so that a tug by a fisherman on a fishing line connected to the fishing lure body causes the tilting of the fishing lure to trigger the motion switch to activate the electronic circuit and the chip to produce the pre-recorded sound of the bait creature.

3. The device of claim 2 wherein the fishing lure body simulates the body of the bait creature which produces the sound recorded and reproduced by the sound module in the fishing lure body and the tug on the fishing line creates motion in the fishing lure body to simulate motion of the bait creature.

4. The device of claim 1 wherein the recorded sound producing chip generates a pre-recorded simulated sound or actual sound of a live bait creature sound taken in a natural environment and taken from a list of bait creature sounds including a frog ribbit sound, a basspop cricket sound, a baby hatchling alligator squeaking sound, a mouse sqeaking sound, a crayfish clicking sound, a shad rattling buzzing sound, a rat squeaking sound, a small fish sound in the water, and an aquatic insect sound in the water.

5. The device of claim 1 wherein the power source comprises a rechargeable battery connected to an inductance pickup coil and further comprising an inductance coupled battery charger comprising a receptacle for receiving the lure therein and a mating inductance coupling coil adjacent to the receptacle so that the coils are in close proximity to charge the battery inside the module and the lure.

6. The device of claim 5 wherein the sound module further comprises an on-off magnetic latch switch so that swiping a south pole of a magnet past the lure activates the sound module circuit for use in the water and swiping a north pole of a magnet past the lure de-activates the sound module circuit for storage.

7. The device of claim 1 wherein the module further comprises an electrically conductive means for attaching the fishing line at a forward end and an electrically conductive means attaching at least one hook at a rearward end, and the power source comprises a rechargeable battery which connects to the means for attaching the fishing line and the means for attaching at least one hook so that the rechargeable battery is rechargeable inside the sound module by attaching a means for charging the battery to the means for attaching the fishing line and the means for attaching at least one hook without removing the rechargeable battery from the sound module.

8. The device of claim 1 wherein the means for recording and broadcasting a bait creature sound comprises a remote radio controlled robotic fishing lure device simulating the bait creature, the device comprising:
a watertight simulated body of a fishing bait creature comprising an outer shell having a watertight inner space housing, at least one radio receiver and at least one sound simulation actuator, the at least one radio receiver communicating with the at least one sound simulation actuator for generating a sound of a live bait creature;
at least one movable appendage attached to the simulated body with a watertight fit;
a hand and foot operated remote control housing a radio control transmitter, the remote control alternately held by a user in a first position for hand control and alternately positioned near a foot of a user in a second position for foot control while a user holds a fishing rod, the radio control transmitter controlling the robotic fishing lure device for fishing, the radio control transmitter wirelessly communicating with the at least one radio receiver in the body which activates the at least one sound simulation actuator causing the lure to emit a pre-recorded actual or simulated sound of the live bait creature on demand. thereby providing a bait sound producing fishing lure device having self contained electronics inside to broadcast an actual sound reproduction of a bait animal sound when activated by the fisherman.

9. The device of claim 8 further comprising a power source, wherein the at least one radio receiver and at the least one sound simulation actuator and the power source are housed together in a waterproof housing removable inserted in the simulated body so that the waterproof housing may be removed and inserted in a different simulated body.

10. The device of claim 8 wherein the at least one movable appendage comprises a flexible simulated extremity removably attached to the watertight simulated body so that the simulated extremity is removable and replaceable.

11. The device of claim 8 wherein the simulated body has at least one opening through the outer shell and the at least one movable appendage comprises at least one simulated bait creature extremity which fits with a tight watertight fit in one of the at least one openings to plug the opening so that the body is sealed watertight and further comprising at least one magnetic actuator for creating motion positioned within the simulated body in communication with the at least one radio receiver, the at least one magnetic actuator attached to each extremity by means for linking the at least one magnetic actuator to each extremity to enable the at least one magnetic actuator to create movement simulating the natural movement of each extremity.

12. The device of claim 11 further comprising a control arm attached to the magnetic actuator and at least one extremity moving arm extending from inside the simulated body into each extremity, each extremity pivotally attached to the control arm wherein the magnetic actuator imparts a back and forth motion to the control arm and the control arm imparts a movement to the extremity moving arm to create the simulated extremity movement.

13. The device of claim 12 wherein the control arm is further attached to a control arm pivot mechanism connected to an interior surface of the simulated body and the control arm comprises at least one extension control arm portion extending outwardly from the control arm pivot mechanism to connect to the at least one extremity moving arm.

14. The device of claim 13 wherein the control arm has a plurality of extension control arms which each activate an extremity moving arm.

15. The device of claim 11 wherein the magnetic actuator comprises a rare earth magnet actuator imparting motion to at least one control arm.

16. The device of claim 11 wherein the magnetic actuator comprises a servo mechanism imparting motion to at least one control arm.

17. The device of claim 11 further comprising a control wire and spring attached to the magnetic actuator and at least one extremity moving arm extending from inside the simulated body into an extremity, the at least one extremity attached to the control wire wherein the magnetic actuator and spring impart a back and forth motion to the control wire and the control wire imparts a movement to the at least one extremity to create the simulated extremity movement.

18. The device of claim 7 wherein the power source comprises a rechargeable battery within the lure body having battery charger and further comprising means for charging the rechargeable battery within the simulated body.

19. The device of claim 7 wherein the lure body comprises a molded body in a shape of a bait creature taken from a list of bait creatures comprising a frog, a baby alligator, a basspop, a mouse, a chad, a rat, a fish, and an aquatic insect.
